(19) United States
(12) Patent Application Publication
(10) Pub. No.: US 2011/0275503 A1
(43) Pub. Date: Nov. 10, 2011

(54) SINGLE-FOLD INTERFOLDING MACHINE AND METHOD THEREFOR

(75) Inventor: Alessandro De Matteis, Lucca (IT)

(73) Assignee: MTC- MACCHINE TRASFORMAZIONE CARTA S.R.L., Porcari (IT)

(21) Appl. No.: 13/142,477

(22) PCT Filed: Dec. 31, 2009
(86) PCT No.: PCT/EP09/09343

§ 371 Date: Jul. 27, 2011

(30) Foreign Application Priority Data
Dec. 31, 2008 (EP) 08173144.0

(51) Int. Cl. B31B 49/00

(52) U.S. Cl. 493/356

(57) ABSTRACT

An interfolding machine for making a stack of interfolded sheets is adapted to move a first web (10a) of a material to be interfolded, for example paper, non woven fabric, or similar material, along a first direction (101a) and a second web (10b) along a second direction (101b). The two webs of paper (10a, 10b) are dragged by means of respective series of rollers (31-36, 37-45) up to respective cutting sections (20a and 20b) where cutting rollers (2a, 2b) are arranged that in combination with respective counter-cutting rollers (3a, 3b) cut the webs of paper (10a, 10b) in order to form respective sequences of sheets (11a, 11b). The sequences of sheets (11a, 11b) reach then an interfolding section (30) where the sheets (11a) obtained by the first web (10a) and the sheets (11b) obtained by the second web (10b) are folded and then interfolded according to a determined interfolded configuration. Each series of sheets (11a, 11b) has a complete cut (51), or “clean cut”, alternated to a tear-off line (52), or “tab-bond”. The above described configuration avoids the drawbacks of the prior art deriving from the separation of two successive sheets of two different stacks that are joined through a line of “tab-bond” type.

### FIELD OF THE INVENTION

The present invention relates to an improved interfolding machine of single-fold type, for making paper material, and the like, as packages of interfolded sheets with a predetermined number of sheets.

The invention relates, furthermore, to an interfolding method therefor.

### BACKGROUND OF THE INVENTION

As well known, in the paper converting industry a variety of types is used of machines and of processes for making paper tissues, paper towels and similar articles as stacks of a certain height of interfolded sheets, for example as described in EP228687.

They are obtained by folding the sheets in an “interfolded” way, i.e. enclosing within each fold a wing of a previous sheet and a wing a next sheet. This way, when drawing a sheet from the pack, also a wing of the next sheet pops up from the pack, with subsequent practicality of use for certain types of applications. Among possible interfolding ways the L-type, with 2 panels, or the Z or W types, respectively with 3 and 4 panels, are known.

Some interfolding machines of known type, such as EP982256A1 or U.S. Pat. No. 4,494,741, provide a couple of folding rollers that supply the interfolded sheets on a stacking table and, in some cases, a plurality of “hands” is provided that alternately conceal within and protrude from special grooves, which are made on the folding rollers for the production of a stack of interfolded sheets on the stacking table.

When the growing stack reaches a predetermined height, a first and a second plurality of separating elements, which are arranged for all the length of the stack and at opposite sides with respect to it, enter within the stack same. The introduction of the separating elements starts the separation of a formed stack from a growing stack.

Between the separators and the table the introduction is provided also of a sheet stretching board. The completed stack is then located between the table and the sheet stretching board. While the sheet stretching board remains to support the growing stack, the table drops vertically moving the stack already formed away from the growing stack up to cause the separation of the two stacks.

However, the above described interfolding machines, of so-called single-fold type, which perform the interfolding process starting from webs of paper that converge towards the folding rollers, have various drawbacks when they are used to make stacks of interfolded sheets that have three panels, so-called “Z” folding. In particular, in a pack of “Z” interfolded products, it is necessary that two successive sheets are joined by portions that are separated by cut lines, or “tab-bonds”, owing to the odd number of panels.

The presence of “tab-bonds”, which is always necessary in the known single-fold machines for making “Z” type interfolded products, however, complicates remarkably the separation step of a formed stack of sheets from the growing stack, once achieved a desired height of the pack, owing to the need of tearing the tab-bonds during the separation step.

In particular, when tearing the paper of the tab-bonds an unpredictable movement of the sheet occurs, and irregular folds in the starting and final zone of the pack are formed. Furthermore, for the separation of packs it is necessary to use a sheet stretching board, with relevant structural and operative complications in the machine.

A further drawback of the prior art machines is that the first and the last sheet of each stack is torn. Therefore, to avoid that the resulting product has a low quality, it is necessary to provide a very thin tab-bond, which, owing to the other drawbacks as above described, prevents to achieve a high production rate, that is much less than single-fold machines with two or four panel sheets.

For these reasons, this type of machines for making Z-folded sheets has never been used for products of very light paper, like “facial tissue”, but only for heavier products, such as paper towels.

### SUMMARY OF THE INVENTION

It is therefore a feature of the present invention to provide an interfolding machine that provides an interfolded product of “Z” type that is improved with respect to the similar products of the prior art.

It is also a feature of the present invention to provide an interfolding machine that allows achieving a higher production rate with respect to the interfolding machines of the prior art.

It is another feature of the present invention to provide an interfolding machine that is cheap with respect to the interfolding machines of the prior art.

It is a further feature of the present invention to provide an interfolding machine that is adapted to process a wide variety of different paper material types.

It is also a feature of the present invention to provide an interfolding machine that is highly flexible, since it is capable of making interfolded products of different types.

It is also a feature of the present invention to provide an interfolding machine that assists remarkably the separation of two packages of interfolded sheets of “Z” type.

It is still a feature of the present invention to provide an interfolding machine that is structurally much easier than similar machines of the prior art.

These and other objects are achieved by an interfolding machine comprising:
a feeding section equipped with a first plurality of rollers for moving a first web of paper and with a second plurality of rollers for moving a second web of paper;
a cutting section comprising:
   a first cutting means that is adapted to divide the first web of paper into a first plurality of sheets of measured length;
   a second cutting means that is adapted to divide the second web of paper into a second plurality of sheets of measured length;
an interfolding section comprising:
   an interfolding means that is adapted to fold said first and said second plurality of sheets into a determined interfolded configuration to obtain a stack of interfolded sheets;
a separating section for separating a stack of interfolded sheets from the growing stack;
   whose main feature is that the first and the second cutting means comprise a means to provide a cut line, or “clean cut”, and a means to provide a tear-off line, or “tab-bond”, on said first and said second web.

This way, the machine allows to separate the sheets only at the clean-cut lines, without tearing any tab-bonds.

Advantageously, the first and the second cutting means cut the first and the second web of paper, respectively, in combination with respective counter-cut means that act opposite to the web of paper in order to provide the above described division into the first plurality of sheets and into the second plurality of sheets.

Advantageously, the first and the second cutting means provide, each, a cutting roller that is peripherally equipped with:
at least one cutting blade having a profile that is adapted to cut a complete cut, or “clean cut”, on a web of paper;
at least one perforating blade having a profile that is adapted to cut a tear-off line, or “tab-bond” on the web of paper.

In particular, the first and the second cutting means can provide, each, a cutting roller comprising:
a plurality of cutting blades having a profile that is adapted to make a cut, or “clean cut”, on a web of paper, said cutting blades of said plurality arranged peripherally on the cutting roller at a first angle to each other;
a plurality of perforating blades having a profile that is adapted to cut a tear-off line, or “tab-bond”, on said web of paper, said perforating blades arranged peripherally on the cutting roller at a second angle to each other.

Advantageously, the interfolding means are selected from the group comprised of:
suction holes;
mechanical clamps;
a combination thereof.

In particular, the plurality of cutting blades and the plurality of perforating blades are mounted on the boundary of a cutting roller at respective housings in a way movable selectively between an operating position, in which said blades protrude from said cutting roller and cut the web of paper, and a rest position, in which said blades are withdrawn within said cutting roller and cannot cut the web of paper, said cutting blades and/or perforating blades in said operating positions obtaining a desired cutting configuration.

Advantageously, a means is provided for actuating selectively each blade of said plurality of cutting blades and/or of said perforating blades between said operating position and said rest position in order to provide a desired cutting configuration.

In particular, the means for actuating selectively each of said cutting blades and each of said perforating blades between said operating position and said rest position can provide an actuator, for example a pneumatic actuator, having a stem with an end that is connected to the blade and the other end that is arranged in an actuating chamber, said blade being pivotally constrained to said roller at a pivoting point, said end of said actuator sliding in said actuating chamber for causing the rotation of said blade about said pivot point and then the movement of said blade from said operating position to said rest position, or vice-versa.

Alternatively, the means for actuating the blades between the operating position and the rest position provides a carriage that is integral to each blade and slides on a guide, said carriage withdrawing/forwarding with respect to the boundary of the roller along the guide for bringing the blade from the operating position to the rest position, or vice-versa.

In a further exemplary embodiment, the means for actuating the blades between the operating position and the rest position comprises a first plurality of blade holders that are arranged peripherally on the roller at the first angle to each other and a second plurality of blade holders that are arranged peripherally on the roller at the second angle to each other, whereby the blades can be mounted on the roller at the first, or the second, plurality of blade holders to provide the complete cuts, or the tear-off lines, respectively.

In particular, at the separating section first and second separation means are provided that act at opposite sides of the stack and are adapted to be moved between a position that is external to the stack and a position within the stack, said first and second separation means arranged in said position within the stack in points such that the separation of two successive sheets is obtained at a complete cut, or “clean cut”.

More precisely, the first separation means enters the stack at a cut line, or “clean cut” and the second separation means enters the stack opposite to the first separation means in a position immediately upstream of it. This way, after the separation of two consecutive sheets, between the first and the second separation means only one sheet remains hanging that can be easily stretched for finishing the pack.

Advantageously, furthermore, a program means is provided that is adapted to operate electronically said first and second separation means. This way, the separation means is operated with high precision. This way, furthermore, the separation means is prevented from entering the stack in wrong points i.e. in points that bridge two “tab-bonds”, or between a “tab-bond” and a “clean cut”, and the separation means is caused to enter only at two “clean cuts”, as above described.

According to another aspect of the invention, a method for making a stack of interfolded sheets comprises the steps of:
feeding a first and a second web of paper;
cutting the first and the second web of paper in order to provide a first and a second plurality of sheets of measured length, respectively;
interfolding the first and the second plurality of sheets into a determined interfolded configuration to obtain a stack of interfolded sheets;
separating said stack of interfolded sheets from the growing stack and moving away the stack;

said cutting step providing a combination of complete cuts, or “clean cut”, and of tear-off lines, or “tab-bonds” on said first and second web.

This way, the separation of the stacks is carried out only at the clean-cut lines, without tearing, and with simplification of the steps of separation, such that the separation between the formed stack and the growing stack does not require using separation boards for tearing the tab-bonds, since at the clean-cut the separation between the two stacks is obtained freely.

In particular, the above described combination of complete cuts, or “clean cuts”, and of tear-off lines, or “tab-bonds” comprises a step of making a cutting line on each of said first and second web of paper alternated to a step of making a tear-off line.

Advantageously, the step of separating said stack of interfolded sheets from the growing stack is effected by first and second separation means that are adapted to enter the stack, at opposite sides with respect to it, at points of the stack such that the separation of two successive sheets is obtained at a complete cut, or “clean cut”.

According to a further aspect of the invention, an interfolded product comprises a plurality of sheets that are arranged according to a determined interfolded configuration such that two successive sheets of said plurality of sheets are alternately separated by a cut line, or “clean cut”, and a tear-off line, or “tab-bond”.

In particular, the plurality of interfolded sheets comprises a cut line, or “clean cut”, at the first and the last sheet, and a tear-off line, or “tab bond”, at the sheets that are adjacent to said first and said last sheet. This way, the separation between two stacks is carried out always at the complete cut, or “clean cut”.

### BRIEF DESCRIPTION OF THE DRAWINGS

Further characteristic and the advantages of the interfolding machine, according to the invention, will be made clearer with the following description of an exemplary embodiment thereof, exemplifying but not limitative, with reference to the attached drawings, in which like reference characters designate the same or similar parts, throughout the figures of which:

FIG. 1 diagrammatically shows an elevational side view of an interfolding machine, according to the invention, for making packages of interfolded sheets;

FIG. 2 shows in detail an elevational front view of a stack of interfolded sheets of “Z” type obtained with the machine of FIG. 1;

FIGS. from 3 to 5 show elevational side views of three possible exemplary embodiments of a cutting roller according to the invention;

FIG. 6 shows an elevational side view of the cutting roller of FIG. 5 in a first cutting configuration;

FIG. 7 diagrammatically shows an elevational side view of a stack of interfolded sheets as it is obtained with the cutting configuration of FIG. 6;

FIG. 8 shows an elevational side view of the cutting roller of FIG. 5 in a second cutting configuration;

FIG. 9 diagrammatically shows an elevational side view of a stack of interfolded sheets as it is obtained with the cutting configuration of FIG. 8;

FIG. 10 shows an elevational side view of the cutting roller of FIG. 5 in a third cutting configuration;

FIG. 11 diagrammatically shows an elevational side view of a stack of interfolded sheets as it is obtained with the cutting configuration of FIG. 10;

FIGS. 12 and 13 show in detail a possible device of handling the blades of the cutting roller of FIG. 5 between a cutting position and a neutral position.

### DESCRIPTION OF A PREFERRED EXEMPLARY EMBODIMENT

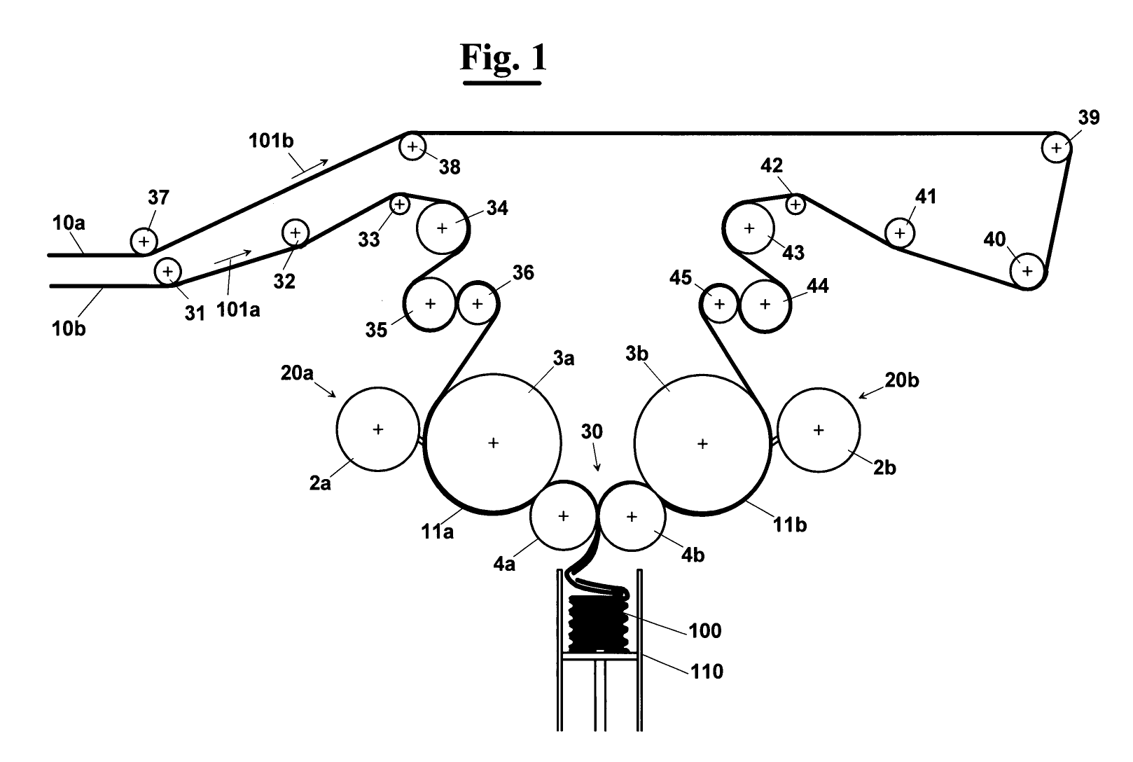

With reference to FIG. 1, an interfolding machine for making a stack of interfolded sheets is adapted to move a first web 10a and a second web 10b of a material to interfold, for example paper, non woven fabric, or similar material, respectively along a first direction 101a and along a second direction 101b.

More precisely, the two webs of paper 10a and 10b are dragged by respective series of rollers 31-36 and 37-45 up to respective cutting sections 20a and 20b, where cutting rollers 2a and 2b are arranged that in combination with respective counter cutting rollers 3a and 3b cut into sheets the webs of paper 10a and 10b, in order to form respective sequences of sheets 11a and 11b.

The sequences of sheets 11a and 11b reach then an interfolding section 30, where the sheets 11a that have been obtained by the first web 10a and the sheets 11b that have been obtained by the second web 10b are folded in an interfolded way in order to form a stack 100 having a determined interfolded configuration.

In particular, at the interfolding section 30, the cut sheets 11a and 11b, which have all the same length, are folded into the interfolded configuration by counter-rotating folding rollers 4a, 4b.

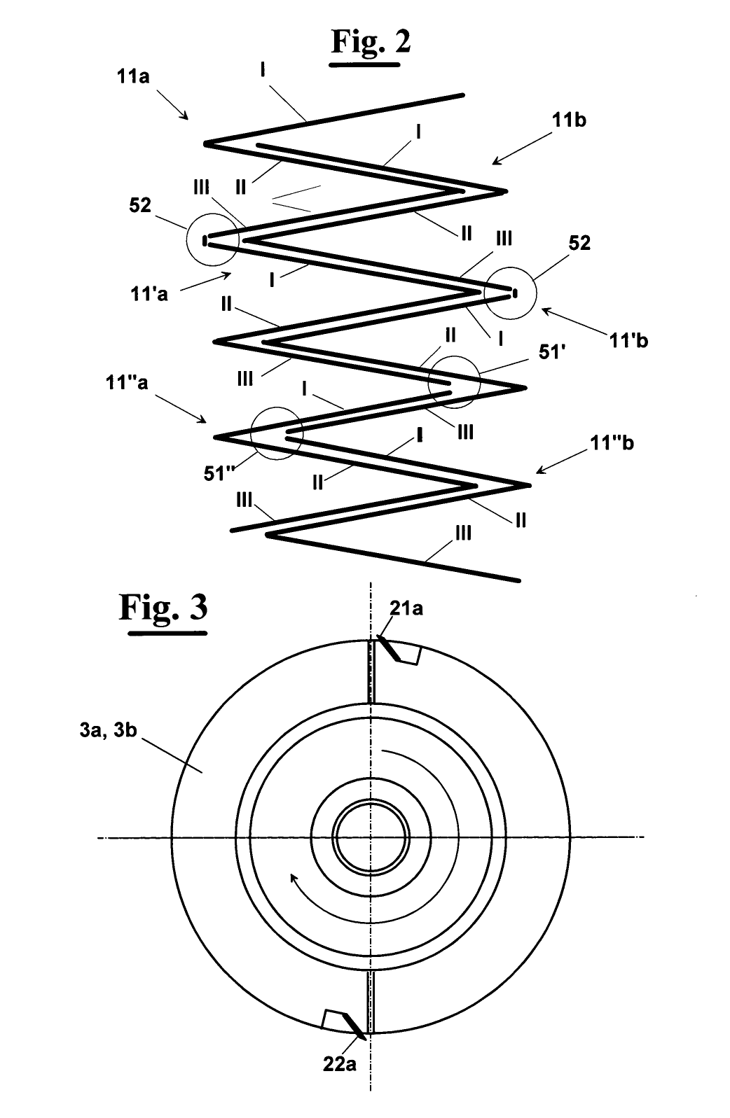

With reference to FIG. 2, in a stack 100 of interfolded sheets of “Z” type, each sheet 11a of a first series of sheets, as they are obtained by cutting web 10a, comprises 3 panels I-III, where panels II and III are overlapped to the panels I and II of a sheet 11b of the second series of sheets, as they are obtained by cutting web 10b.

According to the invention, each series of sheets 11a and 11b has a complete cut 51, or “clean cut”, alternated to a tear-off line 52, or “tab-bond”.

The above described configuration avoids the above described drawbacks of the prior art machines, that are due to the separation of two successive sheets of two different stacks that are joined by a line of “tab-bond” type.

In fact, according to the invention, the separation means of two stacks of successive sheets is operated only at two lines of complete cut, or “clean cut”.

With reference to FIG. 3, a possible exemplary embodiment of a cutting roller 2a, or 2b, which is capable of providing alternately, a complete cut line, or “clean cut” and a tear-off line, or “tab-bond”, on the web of paper 10a, or 10b, in order to provide a stack of interfolded sheets as shown in FIG. 2, provides a cutting blade 21a and a perforating blade 22a that are arranged at an angle 180° to each other.

Alternatively, as shown in FIG. 4, each cutting roller 2a, or 2b, comprises a first blade 21a and a second blade 21b, which have a profile that is adapted to cut a complete cutting line of “clean cut” type and are arranged at an angle to each other equal to 180°, and also two perforating blades 22a and 22b, which have a profile that is adapted to cut a tear-off line “tab-bond” type and are arranged at an angle 90° to each other.

In a further exemplary embodiment that is shown in FIG. 5, each cutting roller 2a, or 2b has peripherally a first series of blades 21a-21f that are arranged at first angular positions and has a second plurality of blades 22a-22b that are arranged at second angular positions.

More precisely, blades 21a-21f of the first series of blades are arranged at a first angle to each other equal to 60° starting from a reference position P0. Blade 22a of the second series of blades is arranged at a position P1 at an angle 90° to the actual reference position P0, whereas blade 22b of the second series of blades is arranged at a position P2 at an angle 270° to the actual reference position P0.

More in detail, blades 21a-21f of the first series comprise a cutting edge that is adapted to provide a complete cut, or “clean cut”, on web 10a, or 10b, whereas blades 22a and 22b of the second series has a cutting profile that is adapted to provide a tear-off line, or “tab bond”, on web 10a, or 10b.

Blades 21a-21f of the first series and blades 22a and 22b of the second series are, therefore, operated responsive to the desired interfolded configuration.

In this case, by operating selectively the blades of the first series 21a-21f and/or the blades of the second series 22a and 22b it is possible to obtain different interfolded configurations. More in detail, according to the type of desired interfolded configuration a desire cutting configuration is obtained by arranging selectively blades 21a-21f and 22a and 22b in a cutting/perforating position, in which they protrude from the roller surface 2a, or 2b, and lay in a circumference C1, or in a “neutral” position in which they do not cut/perforate the web of paper 10a, or 10b, and lay in a circumference C2.

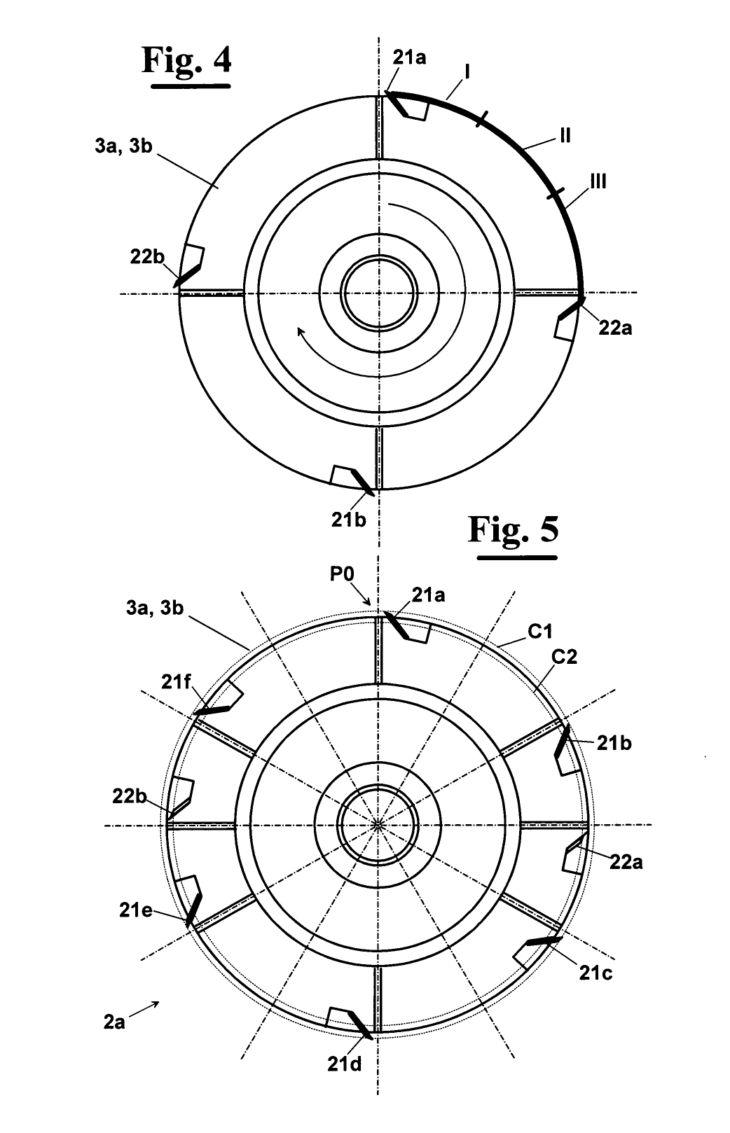

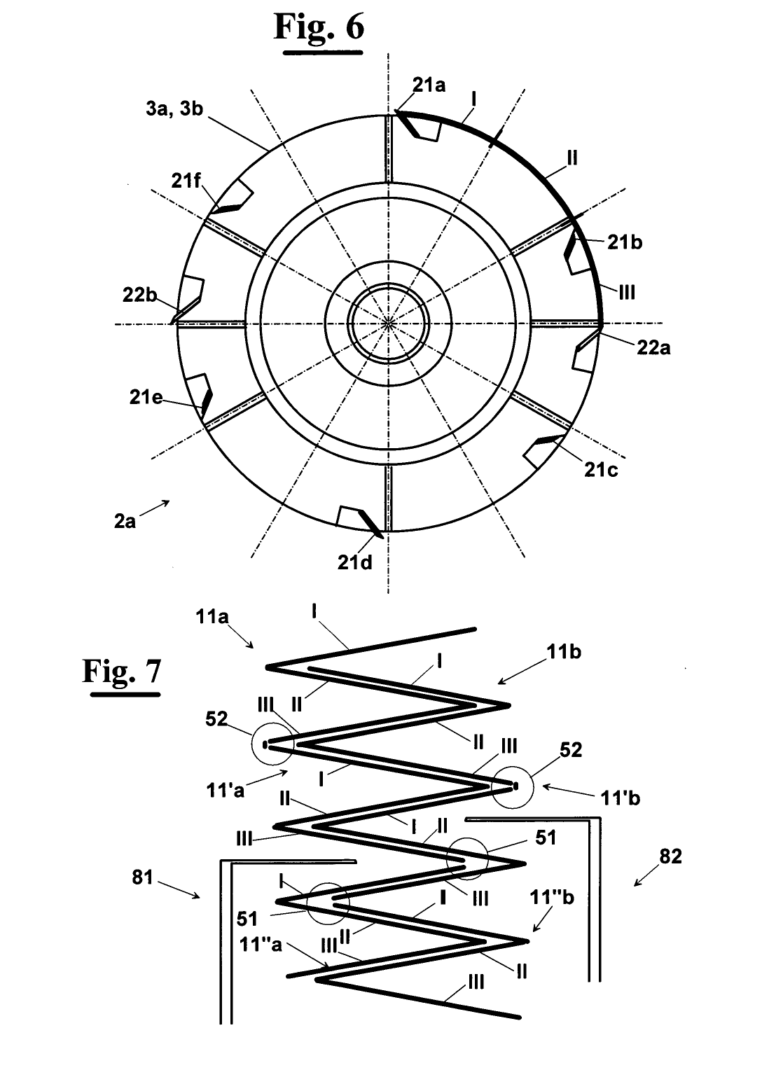

For example, as shown in FIG. 6, in order to make an interfolded configuration of “Z” type, blades 21a and 21d of the first series of blades are operated to provide a complete cut line, or “clean cut”, on the respective web of paper 10a, or 10b, and blades 22a and 22b of the second series of blades provide a tear-off line 52, or “tab-bond”, between two cuts 51 (FIG. 7).

In particular, a separation means is provided that is adapted to pass from a position that is external to the stack to a position within the stack, in which it causes the separation of two consecutive sheets. More precisely, the separation means comprises a first separator 81 and a second separator 82 that act at opposite sides of the stack. When making the separation of two consecutive sheets, separators 81 and 82 enter the stack at points of the stack such that the separation of two successive sheets is obtained at two lines of complete cut, or “clean cut” 51.

In particular, first separator 81 enters stack at a complete cut 51, whereas separator 82 enters stack in a next upstream position with respect to separator 81, with respect to the conveying direction of the stack (FIG. 7). This way, the separation is carried out at the lines of clean cut 51 and after the separation only one panel of a sheet remains free between the two separator 81 and 82. To ensure that the separation step is made with high precision, a program means is provided that is adapted to operate separators 81 and 82 between the position external to the stack and the position within the stack.

In case of an “L” type interfolded configuration, instead, where two sheets 11a and 11b comprise, each, two panels I and II that are interfolded by one panel, all the sheets 11 of the stack are separated by a complete cut, or “clean cut” 51 (FIG. 9).

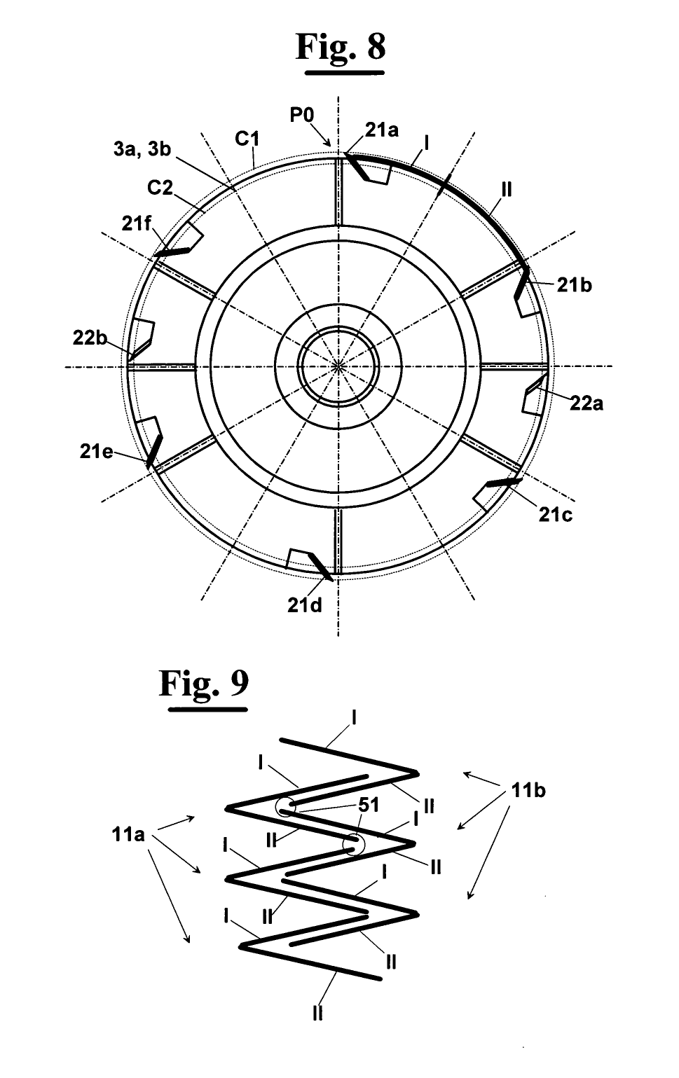

Therefore, in this case all the six blades of “clean cut” type of each roller 2a and 2b are arranged in the cutting position, whereas blades 22a and 22b of the second series are arranged in the withdrawn position (FIG. 8).

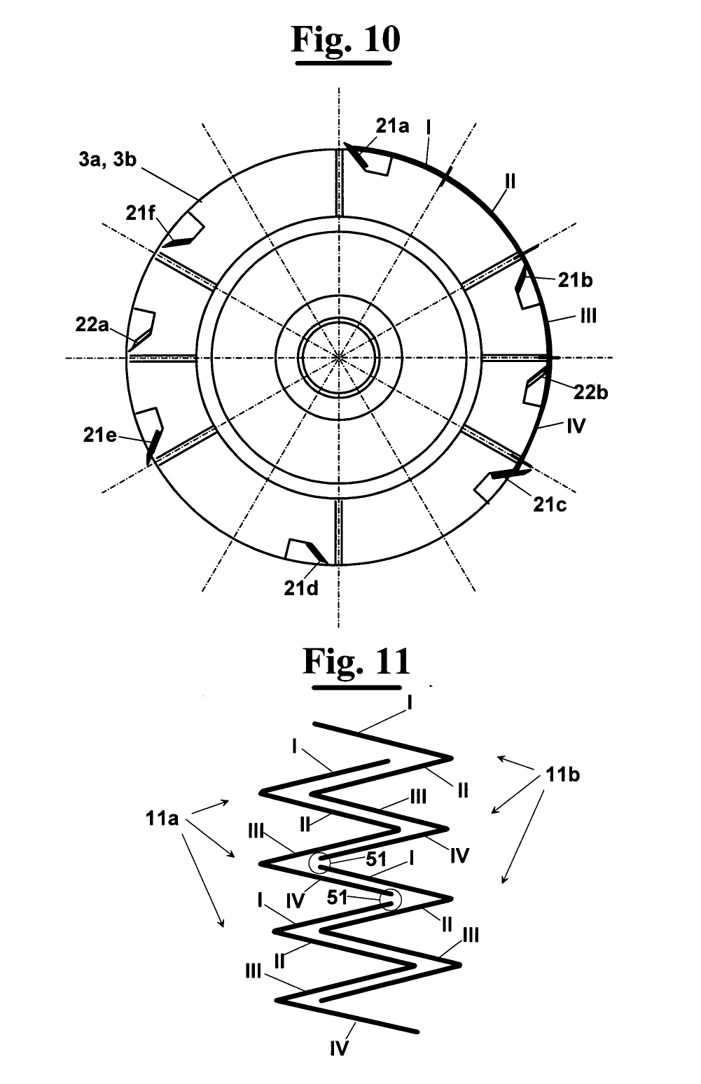

If, instead, an interfolded “W” configuration has to be obtained, where two successive sheets 11a and 11b of the stack have 4 panels each interfolded for 2 panels (FIG. 11), only blades 21a, 21c and 21e of the first series of blades of each cutting roller 4a and 4b (FIG. 10) are operated. Blades 21a, 21c and 21e are, in particular, arranged 120° to each other on a respective cutting roller 4a and 4b, and they can be arranged in a cutting position in which they protrude from the boundary thereof. The other blades 21b, 21d and 21f of the first series of blades as well as blades 22a and 22b of the second series of blades are arranged in a withdrawn position in which they cannot cut web 10a and 10b. Even in this case, therefore, two successive sheets of each succession of sheets 11a and 11b are separated by a cutting line 51 of “clean cut” type (FIG. 11).

Therefore, the interfolding machine, as above described, is highly flexible and capable of providing all the different interfolded configurations that can be achieved with machines of “single-fold” type.

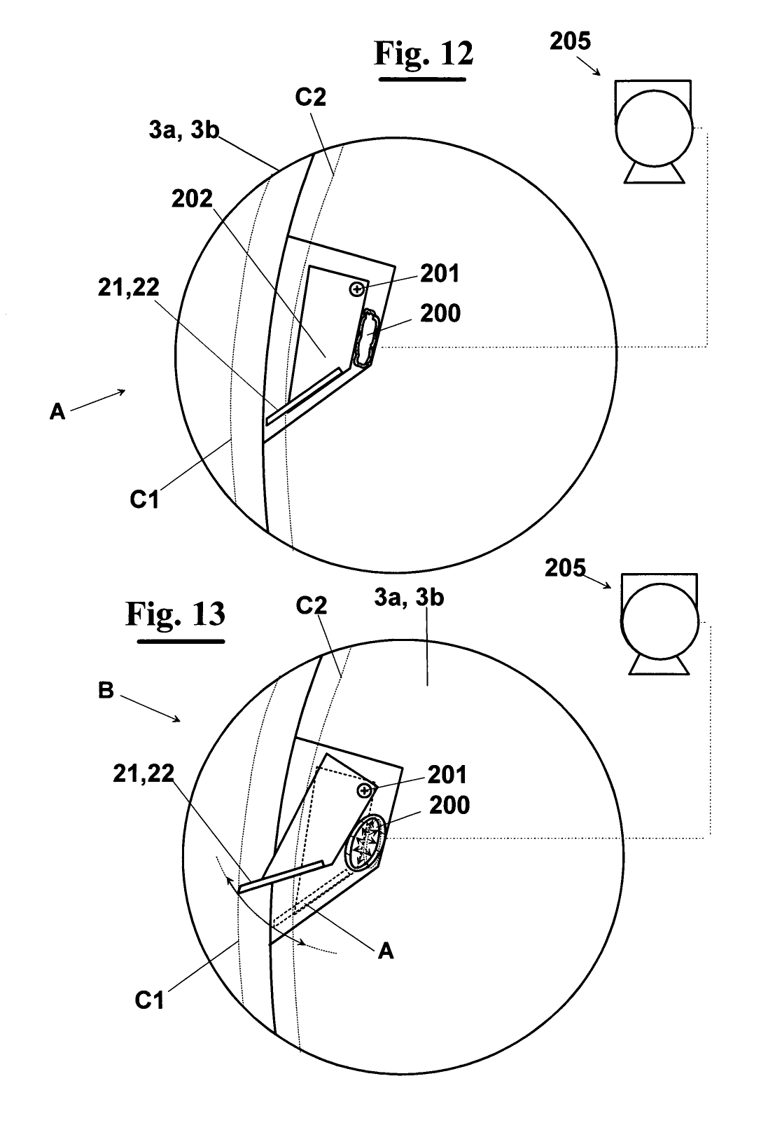

In FIGS. 12 and 13 a possible device is diagrammatically shown that can be used for bringing each blade of first series 21a-21f and each blade of second series 22a and 22b from the cutting position to a “neutral” position. In particular, each blade of first series 21a-21f and of second series 22a and 22b, is arranged in a recess 203 of either cutting rollers 3a, 3b, and is associated with a flexible duct 200 that is in communication with a inflation/deflation device. The latter comprises a reversible pump means 205 that is adapted pump a fluid towards/away from flexible duct 200.

More in detail, when flexible duct 200 is not run by the fluid, it moves to a deflated configuration such that blade 21, or 22, which is associated with it, is brought to a “neutral” position A on circumference C2, in which it does not act on the web of paper (FIG. 12).

When, instead, the duct 200 is run by the inflation fluid, it turns into an inflated configuration and forces from under the corresponding blade-holder 202 to rotate about a pivot point 201 in order to bring the respective blade 21, or 22, to the cutting position B on circumference C1 in which it acts on the web of paper (FIG. 13).

Alternative devices for actuating the blades can be provided as alternative mechanical implementations obvious to a skilled person.

An actuator, for example a pneumatic actuator, can be provided (not shown) having a stem with an end that is connected to the blade and the other end that is arranged in an actuating chamber. The blade is pivotally constrained to the roller at a pivoting point, and the end of the actuator sliding in the actuating chamber for causing the rotation of the blade about the pivot point and then the movement of the blade from the operating position to the rest position, or vice-versa;

In a further alternative (not shown) a carriage can be provided that is integral to each blade and slides on a guide, the carriage withdrawing/forwarding with respect to the boundary of the roller along the guide for bringing the blade from the operating position to the rest position, or vice-versa.

In still another alternative (not shown) a first plurality of blade holders are arranged peripherally on the roller at the first angle to each other and a second plurality of blade holders are arranged peripherally on the roller at the second angle to each other, whereby the blades can be selectively mounted on the roller at the first, or the second plurality of blade holders in order to make either the complete cuts, or the tear-off lines, respectively.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Interfolding machine comprising:
a feeding section equipped with a first plurality of rollers (31-36) for moving a first web (10a) of paper and with a second plurality of rollers (37-45) for moving a second web (10b) of paper;
a cutting section comprising:
a first cutting means (20a, 2a, 3a) that is adapted to divide the first web (10a) of paper into a first plurality of sheets (11a) of measured length;
a second cutting means (20b, 2b, 3b) that is adapted to divide the second web (10b) of paper into a second plurality of sheets (11b) of measured length;
an interfolding section (30) comprising:
an interfolding means (4a, 4b) that is adapted to fold said first and said second plurality of sheets (11b) into a determined interfolded configuration to obtain a stack (100) of interfolded sheets;
a separating section (110) for separating a stack of interfolded sheets from the growing stack (100);
characterised in that said first and said second cutting means (20a, 2a, 3a; 20b, 2b, 3b) comprises a means to provide a cut line, or “clean-cut” (51), and a means to provide a tear-off line, or “tab-bond” (52), on said first and said second web (10b).

2. Interfolding machine, according to claim 1, wherein said first and said second cutting means (20a; 20b) are adapted to cut said first and said second web (10a,10b) of paper, respectively, to provide a cut line, or “clean-cut” (51), and a means to provide a tear-off line, or “tab-bond” (52), in combination with respective counter-cut means (2a; 2b) that act opposite to said web of paper (10a, 10b) with respect to said cutting means (3a; 3b) to make said cut to form said first plurality of sheets (11a) and said second plurality of sheets (11b).

3. Interfolding machine according to claim 1, wherein the first and the second cutting means (20a, 20b) provide, each, a cutting roller (3a; 3b) that is peripherally equipped with:
at least one cutting blade (21) having a profile that is adapted to cut a complete cut, or “clean cut” (51), on a web of paper;
at least one perforating blade (22) having a profile that is adapted to cut a tear-off line, or “tab-bond” (52) on the web of paper.

4. Interfolding machine according to claim 1, wherein said first and the second cutting means (20a, 20b) provide each a cutting roller comprising:
a plurality of cutting blades (21a, 21b) having a profile that is adapted to make a cut, or “clean cut” (51), on a web of paper, said cutting blades (21a, 21b) of said plurality arranged peripherally on the cutting roller (3a,3b) at a first angle to each other;
a plurality of perforating blades (22a,22b) having a profile that is adapted to cut a tear-off line, or “tab-bond” (52), on said web of paper, said perforating blades (22a,22b) arranged peripherally on the cutting roller (3a,3b) at a second angle to each other.

5. Interfolding machine according to claim 4, wherein said plurality of cutting blades (21) and said plurality of perforating blades (22) are mounted on the boundary of a cutting roller (3a,3b) at respective housings in a way movable selectively between an operating position, in which said blades protrude from said cutting roller (3a,3b), and a rest position, in which said blades are withdrawn within said cutting roller (3a,3b), said cutting blades (21) and/or perforating blades (22) adapted to be arranged at said operating positions obtaining a desired cutting configuration.

6. Interfolding machine according to claim 5, wherein a means is provided for actuating selectively each blade of said plurality of cutting blades (21a-21f) and of said perforating blades (22a,22b) between said operating position and said rest position in order to provide a desired cutting configuration.

7. Interfolding machine according to claim 6, wherein said means for actuating selectively each of said cutting blades (21a-21f) and each of said perforating blades (22a,22b) between said operating position and said rest position, are selected from the group comprised of:
an actuator, for example a pneumatic actuator, having a stem with an end that is connected to the blade and the other end that is arranged in an actuating chamber, said blade being pivotally constrained to said roller at a pivoting point, said end of said actuator sliding in said actuating chamber for causing the rotation of said blade about said pivot point and then the movement of said blade from said operating position to said rest position, or vice-versa;
a flexible duct (200) that is arranged under said blades and is in communication with a inflation/deflation (205) that is adapted to selectively pump a fluid towards/away from flexible duct (200), such that the blades can be moved from a “neutral” position (A) in which it does not act on the web of paper, and a cutting position (B) in which it acts on the web of paper;
a carriage that is integral to each blade and slides on a guide, said carriage withdrawing/forwarding with respect to the boundary of said roller along said guide for bringing said blade from said operating position to said rest position, or vice-versa.
a first plurality of blade holders that are arranged peripherally on said roller at said first angle to each other and a second plurality of blade holders that are arranged peripherally on said roller at said second angle to each other, whereby said blades can be mounted on said roller at said first, or said second plurality of blade holders in order to make either said complete cuts, or said tear-off lines, respectively.

8. Interfolding machine according to claim 1, wherein, a first and second separation means (81, 82) are provided arranged at said separating section (110), said first and second separation means (81, 82) acting at opposite sides with respect to the stack (100) and adapted to be moved between a position that is external to the stack and a position within the stack, said first and second separation means (81, 82) arranged in said position within the stack in points such that the separation of two successive sheets is obtained at a complete cut, or “clean cut” (51) and not at a tear-off line (52).

9. Interfolding machine according to claim 8, wherein, furthermore, a program means is provided that is adapted to operate electronically said first and second separation means.

10. Method for making a stack of interfolded sheets comprising the steps of:
feeding a first and a second web (10b) of paper;
cutting said first and said second web (10b) of paper in order to provide a first and a second plurality of sheets (11b) of measured length, respectively;
interfolding said first and said second plurality of sheets (11b) into a determined interfolded configuration to obtain a stack (100) of interfolded sheets;
separating said stack (100) of interfolded sheets from a growing stack and moving away the stack (100);
characterised in that said cutting step provides a combination of steps of making complete cuts, or “clean cut” (51), and tear-off lines, or “tab bond” on said first and second web (10b).

11. Method, according to claim 10, wherein said combination of steps comprises a step of making a complete cut line, or “clean cut” (51), on each of said first and second web (10b) of paper alternated to a step of making a tear-off line, or “tab-bond” (52).

12. Method, according to claim 10, wherein said step of separating said stack of interfolded sheets from the growing stack is effected by means of first and second separation means (81,82) that act at opposite sides of the stack and are adapted to enter the stack in corresponding points of the stack such that they cause the separation of two successive sheets at two lines of complete cut, or “clean cut” (51).

13. Interfolded product comprising a plurality of sheets that are arranged according to a determined interfolded configuration characterised in that two successive sheets of said plurality of sheets (11a,11b) are alternately separated by a cut line, or “clean cut” (51), and a tear-off line, or “tab bond”.

14. Interfolded product comprising a plurality of sheets that are arranged according to a determined interfolded configuration characterised in that it comprises a plurality of complete cuts, or “clean cut” (51), alternate to a plurality of tear-off lines, or “tab bond” (52).

15. Interfolded product comprising a plurality of sheets that are arranged according to a determined interfolded configuration characterised in that it comprises a cut line, or clean cut, at the first and the last sheet of said plurality of sheets, and tear-off lines, or “tab bond”, at the sheets that are adjacent to said first and said last sheet.
